(19) United States
(12) Patent Application Publication
(10) Pub. No.: US 2014/0325100 A1
(43) Pub. Date: Oct. 30, 2014

(54) DATA MANAGEMENT SYSTEM FOR DATA COMMUNICATION AND METHOD THEREFOR

(71) Applicants: Intellectual Discovery Co., Ltd., Seoul (KR); Vault Micro, Inc., Seoul (KR)

(72) Inventors: Tae Wook JUNG, Goyang-si (KR); Yong Hoon KIM, Osan-si (KR)

(73) Assignees: Intellectual Discovery Co., Ltd., Seoul (KR); Vault Micro, Inc., Seoul (KR)

(21) Appl. No.: 14/266,273

(22) Filed: Apr. 30, 2014

(30) Foreign Application Priority Data
Apr. 30, 2013 (KR) 10-2013-0048312
Apr. 30, 2013 (KR) 10-2013-0048322

(51) Int. Cl. G06F 13/10

(52) U.S. Cl. CPC G06F 13/10
USPC 710/72

(57) ABSTRACT

The present invention relates to a data management system and a data management method for data communications. The system and method can reduce load of a data control device, minimize costs for interworking and costs such as time and technologies needed for product commercialization, and enhance stability and extensibility of the product by adding a data management device between the data control device and a plurality of peripheral devices and controls the data control device to use a single unified standard protocol in order to control the plurality of peripheral devices.

### CROSS REFERENCE TO RELATED APPLICATIONS

This application claims priority from and the benefit of Korean Patent Application No. 10-2013-0048312, filed on Apr. 30, 2013, and Korean Patent Application No. 10-2013-0048322, filed on Apr. 30, 2013, each of which is hereby incorporated by reference for all purposes as if fully set forth herein.

### BACKGROUND

1. Field

The present invention relates to a data management system using a device-group-specific data conversion table and a method for the same, and more specifically to a data management system and a method for the same, in which a data management device for managing data communications between a data control device and a plurality of peripheral devices is added between them, and the data control device can control the plurality of peripheral devices by using a unified standard protocol, whereby load of the data control device can be reduced, and costs for interworking can be minimized, and costs such as time and technologies needed for product commercialization can be innovatively reduced, and stability and extensibility of the product can be enhanced.

Also, the present invention can decrease costs for data communications and provide an environment to which a new peripheral device can be easily installed by adding the data management device for managing data communications between the data control device and the plurality of peripheral device, and controlling the data control device to use a unified standard protocol for controlling the plurality of peripheral devices.

2. Discussion of the Background

Generally, in case of a modern computing device such as a personal computer (PC), a laptop, and a personal digital assistant (PDA), the computing device is usually dependent on a data communication device, a modem which can enable communications through an interface such as a IEEE 802.11, a Code Division Multiple Access (CDMA), a General Packet Radio Service (GPRS), an Universal Mobile Telecommunications System (UMTS), etc.

Operating system (OS) being executed in such the computing device usually supports, in order to perform data transmission and reception, a software application client such as a connection manager client using a communication capability provided by the data communication device.

The data communication device itself can provide the software applications being executed in the computing device with various services such as a network access service for accessing a network system state, a wireless data service for transceiving data through a wireless link, and a device management service for accessing a device identifier and a power level status.

Physically, communications between the computing device and the data communication device may be performed through a physical interconnection such as a serial bus including an USB, a RS-232, a PCI, and a PCMCIA and a wireless interface including a Bluetooth and an IEEE 802.11.

For upper layer communications between application clients being executed in the computing device and services being executed in the data communication device, that is, in case of client-service interface, protocols used in the conventional technologies may include an AT command set (defined for a W-CDMA 3GPP terminal in ‘AT command set for User Equipment (3GPP TS 27.007 V3.13.0 (2003)’ and defined for a CDMA 3GPP2 terminal in ‘Data Service Options for Spread Spectrum Systems: AT Command Processing and the Rm Interface (3GPP2 C.S0017-003-A)’), a Remote Network Drive Interface Specification (RNDIS), and a Universal Plug and Play (UPnP).

Currently, as the computing device supports the increased number of communication applications, the data communication device can support various communication technologies. For example, a laptop computer uses a modem supporting a Bluetooth, an IEEE 802.11, and a CDMA to execute communication applications such as a web browser, an e-mail, and a calendar synchronization.

Meanwhile, while a personal computer comprises various controllers for controlling external devices, and a main controller (e.g. a central processing unit (CPU)) can communicate with peripheral devices (or, external devices) through the various controllers, current embedded devices adopt a form of star-topology in which a main controller directly controls peripheral devices.

Here, the star-topology means a form in which a central main computer is connected to multiple small computer systems. In this topology, the small computer systems communicate with other computers through the central computer, and share a data base of the central computer. Also, since the central computer and all computer systems separated from the central computer are connected to the terminals, any terminal can communicate with other terminals in a communication network.

However, the configuration of the embedded devices according to the star-topology causes heavy load of the main controller (CPU) and more time, efforts, and costs for product commercialization. Especially, technical supports such as addition of registers for supporting various interfaces of various devices which can be connected to the main controller (CPU) should be provided. In addition, there may be disadvantage that continuous efforts are needed according to advents of various interfaces which are not standardized.

Especially, when a peripheral device or a peripheral bus which is not supported by an embedded System-On-a-Chip (SoC) is used, modification on the SoC or supplementary module should be used. In this case, due to the changed system, a further cost and verification time for added or modified hardware and software are needed.

### SUMMARY

The present invention is introduced in order to solve the above-described problems. An objective of the present invention is providing a data management system and a method using a device-group-specific data conversion table, which can reduce load of a data control device, minimize costs for interworking and costs such as time and technologies needed for product commercialization, and enhance stability and extensibility of the product by adding a data management device between the data control device and a plurality of peripheral devices and controls the data control device to use a single unified standard protocol in order to control the plurality of peripheral devices.

Another objective of the present invention is providing a data management system and a method using a device-group-specific data conversion table, in which a data management device supports direct communications between peripheral devices so that functions provided by a peripheral device can be used without intervention of a data control device, and overhead of the data control device can be reduced, and overall performances of the system can be further enhanced.

Other objective of the present invention is providing a data management system and a method using a device-group-specific data conversion table, which can reduce physically-required costs for data communications and provide an environment to which a new peripheral device can be easily added.

In order to achieve the objective of the present invention, a first aspect of the present invention may provide a data management system using a device-group-specific data conversion table, the system comprises a plurality of peripheral devices; a data control device for controlling input/output data of each of the plurality of peripheral devices; and a data management device connected between the plurality of peripheral devices and the data control device in order to manage data communications between them, wherein the data management device is provided with device data outputted from each of the plurality of peripheral devices, and converts the device data into a packet having a device control data format which the data control device can interpret by using a preconfigured device-group-specific data conversion table, wherein the data management device is provided with a packet having a device control data format corresponding to a target peripheral device transmitted from the device control device, and converts the packet into a device control data format which the target peripheral device demands by using the preconfigured device-group-specific data conversion table.

Here, the data management device may comprises a data transceiving part transceiving data between the data control device and each of the plurality of peripheral devices; and a data management control part being provided with received device data of each of the plurality of peripheral devices from the data transceiving part, converting the device data into a packet having a device control data format which the device control device can interpret by using the device-group-specific data conversion table, controlling the data transceiving part to transmit the packet to the data control device, being provided with a received packet having a device control data format corresponding to the target peripheral device from the data transceiving part, converting the packet into a device control data format demanded by the target peripheral device by using the preconfigured device-group-specific data conversion table, and controlling the data transceiving part to transmit the device control data format to the target peripheral device.

Here, the data management control part may be provided with device data outputted from each of the plurality of peripheral devices from the data transceiving part, converts the device data into a packet having a device control data format by using the device-group-specific data conversion table, add target information of another peripheral device to the device data if a target of the device data is the another peripheral device, convert the device data into a device control data format which the another peripheral device can interpret by using the device-group-specific data conversion table, and control the data transceiving part to transmit the device control data format to the another peripheral device.

Here, the data management control part may be provided with device data outputted from each of the plurality of peripheral devices through the data transceiving part, and control the data transceiving part to transmit the device data to the data management device or another peripheral device according to target information of the device data. Also, when the target information of the device data indicates the data control device, the data management control part may convert the device data into a packet having a corresponding device control data format by using the device-group-specific data conversion table, and control the data transceiving part to transmit the packet to the data control device. Also, when the target information of the device data indicates the another peripheral device, the data management control part may convert the device data into a device control data format which the another peripheral device can interpret by using a preconfigured inter-device data conversion table, and control the data transceiving part to transmit the device control data format to the another peripheral device.

Here, the inter-device data conversion table may include mapping information for interconversion between data formats used by the plurality of peripheral devices connected to each other.

Here, the data control device may be connected to the data management device through a single unified communication channel, be provided with a packet having a device control data format from the data management device through the single unified communication channel, and transfer the packet to a device driver for controlling a corresponding peripheral device. Also, the data control device may be provided with a packet having a device control data format outputted from a target device driver connected to a preinstalled application program, and transmit the packet to the data management device through the single unified communication channel.

Here, the device-group-specific data conversion table may include mapping information for interconversion between data formats used by the data control device and the plurality of peripheral devices.

Here, the data management device and the data control device may configure a packet according to a predefined protocol specification, and transmit the packet to each other through a communication channel using a single interface manner.

Here, the device-group-specific data conversion table may classify the plurality of peripheral devices into at least one device group according to characteristic of each of the plurality of peripheral devices, and peripheral devices belonging to a same device group may use a same data format to perform data communications, and peripheral devices belonging to different device groups may use different data formats to perform data communications.

In order to achieve the objective of the present invention, a second aspect of the present invention may provide a method of efficient data communication for a system comprising a plurality of peripheral devices, a data control device controlling input/output data of the plurality of peripheral devices, and a data management device between them, the method comprises (a) receiving, at the data management device, device data outputted from each of the plurality of peripheral devices, converting the device data into a packet having a device control data format which the data control device can interpret by using a preconfigured device-group-specific data conversion table, and transmitting the packet to the device control device; (b) receiving, at the data control device, the packet transmitted in the step (a), and transferring the packet to a device driver for controlling a corresponding peripheral device; (c) transferring, at the data control device, a packet having a device control data format outputted from a target device driver connected to a pre-installed application program; and (d) being provided, at the data management device, with a packet having a device control data format outputted from a target device driver, converting the packet into a device data format which a corresponding target peripheral device demands by using the device-group-specific data conversion table, and transmitting the device data format to the target peripheral device.

Here, in the step (a), the data management device is provided with device data outputted from each of the plurality of peripheral devices, converts the device data into a packet having a device control data format by using the device-group-specific data conversion table, adds target information of another peripheral device to the device data if a target of the device data is the another peripheral device, converts the device data into a device control data format which the another peripheral device can interpret by using the device-group-specific data conversion table, and transmits the converted device control data format to the another peripheral device.

Here, wherein, in the step (a), the data management device is provided with device data outputted from each of the plurality of peripheral devices, and transmits the device data to the data control device or another peripheral device according to target information of the device data, wherein, in the step (a), when the target information of the device data indicates the data control device, the data management device converts the device data into a packet having a corresponding device control data format by using the device-group-specific data conversion table, and transmits the packet to the data control device, wherein, in the step (a), when the target information of the device data indicates another peripheral device, the data management device converts the device data into a device control data format which the another peripheral device can interpret by using a preconfigured inter-device data conversion table, and transmits the device control data format to the another peripheral device.

Here, the inter-device data conversion table includes mapping information for interconversion between data formats used by the plurality of peripheral devices connected to each other.

Here, in the steps (b) and (c), the data control device is connected to the data management device through a single unified communication channel, is provided with a packet having a device control data format from the data management device through the single unified communication channel, and transfers the packet to a device driver for controlling a corresponding peripheral device, wherein, in the steps (b) and (c), the data control device is provided with a packet having a device control data format outputted from a target device driver through the single unified communication channel, and transmits the packet to the data management device through the single unified communication channel.

Here, the device-group-specific data conversion table includes mapping information for interconversion between data formats used by the data control device and the plurality of peripheral devices.

Here, in the steps (a) and (b), transmission and reception of data between the data management device and the data control device may be performed through a communication channel configured in a manner of single interface by configuring packets based on predefined protocol specification.

Here, the device-group-specific data conversion table classifies the plurality of peripheral devices into at least one device group according to characteristic of each of the plurality of peripheral devices, and peripheral devices belonging to a same device group use a same data format to perform data communications, and peripheral devices belonging to different device groups use different data formats to perform data communications.

In order to achieve the objective of the present invention, a third aspect of the present invention may provide a computer-readable medium on which program codes for the above-described data management method using a device-group-specific data conversion table are recorded.

The data management method using the device-group-specific data conversion table according to the present invention may be implemented as computer-readable program codes on a computer-readable medium. The computer-readable medium may include various storage devices in which data and program codes which a computer can read are stored.

For example, the computer-readable medium may include a ROM, a RAM, a CD-ROM, a magnetic table, a hard disc, a floppy disk, a removable storage device, a non-volatile memory (e.g. flash memory), an optical data storage device, etc.

In order to achieve the other objective of the present invention, a first aspect of the present invention may provide a data management system for data communications between a plurality of peripheral devices and a data control device, the system comprises a plurality of peripheral devices; a data management device receiving device data outputted from each of the plurality of peripheral devices, converting the device data into a packet having a device control data format corresponding to a device group to which the each of the plurality of peripheral devices belongs by using a preconfigured device-group-specific data conversion data base, processing the packet into data blocks according to a protocol policy predefined with the data control device; and transmitting the data block based on scheduling performed according to a preconfigured priority; and a data control device receiving the data blocks, reassembling the data blocks into a packet having a device control data format according to their time sequences, and transmitting the packet to a device driver for controlling the corresponding peripheral device.

Here, the data control device converts data outputted form a target device driver connected to a pre-installed application program into a packet having a device control data format which the data management device can interpret, processes the packet into data blocks according to a protocol policy predefined with the data management device, and transmit the processed data blocks based on scheduling performed according to a preconfigured priority, wherein the data management device is provided with the data blocks from the data control device, reassembles the data blocks into a packet having a device control data format corresponding to a target peripheral device according to their time sequences, converts the packet into a device control data format demanded by the target peripheral device by using the device-group-specific data conversion data base, and transmits the device control format to the target peripheral device.

Here, the data management device and the data control device configure a packet according to a predefined protocol specification, and transmit the packet to each other through a communication channel using a single interface manner.

Here, the device-group-specific conversion data base stores and manages mapping information for interconversion between data formats used by the data control device and the plurality of peripheral devices as a data base having a table form.

In order to achieve the other objective of the present invention, a second aspect of the present invention may provide a method of efficient data communication for a system comprising a plurality of peripheral devices, a data control device controlling input/output data of the plurality of peripheral devices, and a data management device between them, the method comprises (a) being provided, at the data management device, with device data outputted from a peripheral device, and converting the device data into a packet having a device control data format corresponding to a device group to which the peripheral device belongs which the data control device can interpret by using a preconfigured device-group-specific data conversion data base; (b) processing, at the data management device, the packet into data blocks according to a protocol policy predefined with the data control device, and transmitting the data blocks based on scheduling performed according to a preconfigured priority; and (c) being provided, at the data control device, with the data blocks, reassembling the data blocks into a packet having a device control data format according to time sequence, and transmitting the packet to a virtual device driver for controlling a corresponding peripheral device.

Here, the method further comprises, after the step (c), (d) converting, at the data control device, data outputted from a target device driver connected to a pre-installed application program into a packet having a device control data format which the data management device can interpret; (e) processing, at the data control device, the packet into data blocks according to a protocol policy predefined with the data management device, and transmitting the data blocks based on scheduling performed according to a preconfigured priority; and (f) being provided, at the data management device, with the data blocks, reassembling the data blocks into a packet having a device control data format according to their time sequences, converting the packet into a device data format demanded by a corresponding target peripheral device by using the device-group-specific data conversion data base, and transmitting the device data format to the corresponding peripheral device.

Here, the data management device and the data control device configure a packet according to a predefined protocol specification, and transmit the packet to each other through a communication channel using a single interface manner.

Here, the device-group-specific conversion data base stores and manages mapping information for interconversion between data formats used by the data control device and the plurality of peripheral devices as a data base having a table form.

In order to achieve the other objective of the present invention, a third aspect of the present invention may provide a computer-readable medium on which program codes for the above-described data management method using a device-group-specific data conversion table are recorded.

The data management method using the device-group-specific data conversion table according to the present invention may be implemented as computer-readable program codes on a computer-readable medium. The computer-readable medium may include various storage devices in which data and program codes which a computer can read are stored.

For example, the computer-readable medium may include a ROM, a RAM, a CD-ROM, a magnetic table, a hard disc, a floppy disk, a removable storage device, a non-volatile memory (e.g. flash memory), an optical data storage device, etc.

### BRIEF DESCRIPTION OF THE DRAWINGS

FIG. 1 is a block diagram to explain a data management system according to an example embodiment of the present invention;

FIG. 2 is a block diagram to explain a data management device and a data control device which are applied to an example embodiment of the present invention.

FIG. 3 is a flow chart to explain the data management method using a device-group-specific data conversion table according to an example embodiment of the present invention;

FIG. 4 is a detailed block diagram to explain a data management device and a data control device which are applied to an example embodiment of the present invention; and

FIG. 5 is a flow chart to explain the data management method for data communications between a plurality of peripheral devices and a data control device according to an example embodiment of the present invention.

### DETAILED DESCRIPTION OF THE ILLUSTRATED EMBODIMENTS

Example embodiments will now be described more fully hereinafter with reference to the accompanying drawings; however, they may be embodied in different forms and should not be construed as limited to the embodiment set forth herein. Rather, these example embodiments are provided so that this disclosure will be thorough ad complete, and will fully convey exemplary implementations to those skilled in the art. Like reference numerals in the drawings denote like or similar elements throughout the specification. The term ‘and/or’ may indicate each item and all combinations of the items.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present invention.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, integers, steps, operations, elements, and/or components, but do not preclude the presence or addition of one or more other features, integers, steps, operations, elements, components, and/or groups thereof.

Unless defined otherwise, all technical and scientific terms used herein have the same meanings as commonly understood by one of ordinary skill in the art to which this invention belongs. Further, unless defined otherwise, all terms defined in generally used dictionaries may not be ideally or overly interpreted.

Also, when it is determined that the detailed description related to a related known function or configuration may make the purpose of the present invention unnecessarily ambiguous in describing the present invention, the detailed description will be omitted here.

All terms used herein are terms defined in consideration of their functions in example embodiments of the present invention. However, the terms may have different meanings according to an intention of one of ordinary skill in the art, precedent cases, or the appearance of new technologies. Thus, the terms used herein have to be defined based on the meaning of the terms together with the description throughout the specification.

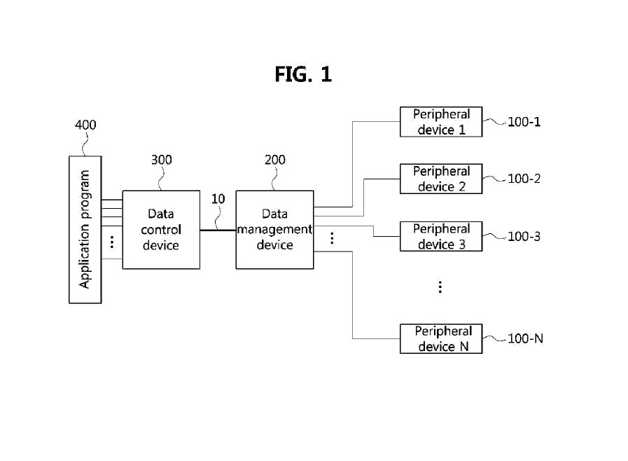

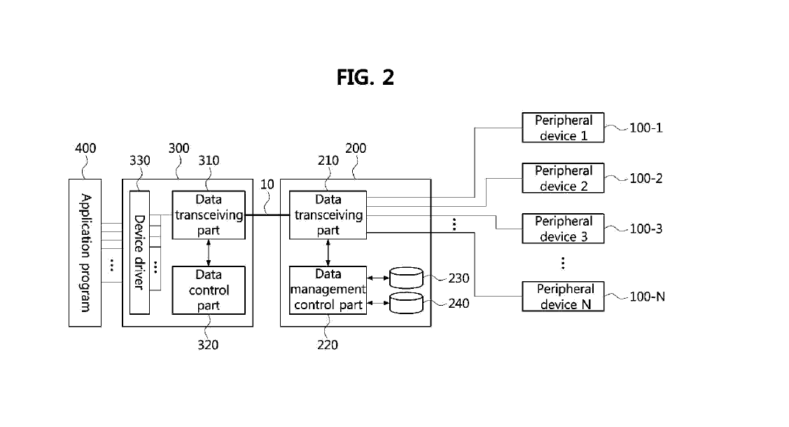

FIG. 1 is a block diagram to explain a data management system according to an example embodiment of the present invention, and FIG. 2 is a block diagram to explain a data management device and a data control device which are applied to an example embodiment of the present invention.

Referring to FIG. 1 and FIG. 2, a data management system using a device-group-specific data conversion table, according to an example embodiment of the present invention, may comprise a plurality of peripheral devices 100-1 to 100-N, a data management device 200, and a data control device 300, etc.

Here, the plurality of peripheral devices 100-1 to 100-N may include input/output devices except a central processing unit (CPU), secondary memory units, data communication devices for online systems, etc.

That is, for example, the plurality of peripheral devices for a smart phone may include components essential to a computer system such as a processor, a memory, a bus, etc. and components which are not essential to the computer system such as a Global Positioning System (GPS) module, a Code-Division Multiple Access (CDMA) communication module, a touch panel, a speaker, a microphone, etc.

Also, the plurality of peripheral devices may be referred to as ‘input/output devices’, and they may include devices providing or outputting some information to a main controller or a central processing unit (CPU), etc.

Meanwhile, peripheral devices such as a hard-disk, a CD-ROM drive, a network interface card, etc. may exist in a main body of the computer system together with principal components of the computer system. Otherwise, peripheral devices such as a printer, an image scanner, etc. may exist out of the main body of the computer system.

Also, the data management device 200 may be a bridge module performing a role of a communication mediator between the plurality of peripheral devices 100-1 to 100-N and the data control device 300, and comprise a physically-implemented chip and a firmware embedded in a chip memory. Such the data management device 200 may be upgraded for supports of new peripheral devices, bug fixing, performance enhancement, etc. by updating internal software.

Especially, the data management device 200 may receive device data outputted from each of the plurality of peripheral devices 100-1 to 100-N, and perform a function of converting the device data into a packet having a device control data format which the data control device 300 can interpret by using a preconfigured device-group-specific data conversion table 230.

Also, the data management device 200 may receive a packet having a device control data format corresponding to a target peripheral device from the data control device 300, and perform a function of converting the packet into a data control data format which the target peripheral device demands by using the device-group-specific data conversion table 230.

Such the data management device 200, as shown in FIG. 2, may comprise a data transceiving part 210 transceiving data between the data control device 300 and the plurality of peripheral devices 100-1 to 100-N; and a data management control part 220 being provided with received device data of each of the plurality of peripheral devices 100-1 to 100-N from the data transceiving part 210, converting the device data into a packet having a device control data format which the data control device 300 can interpret by using the device-group-specific data conversion table 230, and controlling the data transceiving part 210 to transmit the packet to the data control device 300.

Also, the data management control part 220 may be provided with a received packet having a device control data format corresponding to a target peripheral device from the data transceiving part 210, convert the packet into a device control data format which the target peripheral device demands by using the device-group-specific data conversion table 230, and control the data transceiving part 210 to transmit the device control data to the corresponding target peripheral device.

Also, the data management control part 220 may be provided with device data outputted from each of the plurality of peripheral devices 100-1 to 100-N through the data transceiving part 210, and convert the device data into a packet having a device control data format by using the device-group-specific data conversion table 230. After then, if target information of the device data outputted from a corresponding peripheral device indicates another peripheral device, the data management control part 220 may add target information of the another peripheral device to the device data by using a preconfigured target environment information, convert the device data into a device data format which the another peripheral device can interpret, and control the data transceiving part 210 to transmit the converted data format to the another peripheral device.

Here, it is desirable that the preconfigured target environment information is stored and managed in a separate data base as defining relations between data sources and data destinations in order for an arbitrary peripheral device to transmit data to or receive data from the data control device 300 or at least one other peripheral device.

Also, the data management control part 220 is provided with device data outputted from each of the plurality of peripheral devices 100-1 to 100-N through the data transceiving part 210, and controls the data transceiving part 210 to perform transmissions to the data control device 300 or another peripheral device. Thus, if target information of the device data outputted from one of the plurality of peripheral devices 100-1 to 100-N indicates the device control device 300, the data management control part 220 may convert the device data into a packet having a corresponding device control data format by using the device-group-specific conversion table 230, and control the data transceiving part 210 to transmit the packet to the data control device 300.

Meanwhile, if target information of device data outputted from one of the plurality of peripheral devices 100-1 to 100-N indicates another peripheral device, the data management control part 220 may convert the device data into a packet having another device data format by using a preconfigured inter-device data conversion table 240, and control the data transceiving part 210 to transmit it to the another peripheral device.

At this time, it is desirable that the inter-device data conversion table 240 includes mapping information used for mutually converting data formats which are used by peripheral devices connected to each other according to the preconfigured target environment information.

In other words, the data management device 200, as a ‘redirector’ which is used in a network, performs a role of intercepting data being transmitted to a specific target and reconfiguring its direction.

Generally, data generated from the peripheral devices 100-1 to 100-N is transmitted to a main controller which is a destination, that is, the data control device 300. At this time, the data management device 200 may reconfigure a destination of the data as another peripheral device in place of the data control device 300, whereby the data can be directly transmitted to the another peripheral device.

For example, voice date inputted from a first peripheral device (e.g. a microphone device) 100-1 can be directly outputted from a second peripheral device (e.g. a speaker device) 100-2 without intervention of the data control device 300. Also, image data stored in a third peripheral device (e.g. a mass storage device) 100-3 may be directed outputted from a N-th peripheral device (e.g. a printer device) 100-N.

Also, the data management device 200 may perform interconversion between a data format which is demanded by one of the peripheral devices 100-1 to 100-N and a data format which is demanded by the data control device 300.

For example, when ‘0x1E’ is generated as a device data for an action of pressing ‘a’ key in a keyboard peripheral device, if it is assumed that the device data for the action (the pressing ‘a’ key) is defined as ‘0x04’ in the data control device 300 according to a standard for keyboard data format, it is necessary that the actually-generated data ‘0x1E’ is converted into the data ‘0x04’ in order to notify the data control device 300 that the ‘a’ key is pressed.

As described above, the data format demanded by each of the peripheral devices 100-1 to 100-N and the data format demanded by the data control device 300 may be different from each other. In this case, the data management device 200 can perform interconversion between the two data formats. For the interconversion, the data management device 200 may refer to the device-group-specific conversion table 230 in which generated values are respectively mapped onto values into which the generated values should be converted.

Here, it is desirable that the device-group-specific data conversion table 230 is stored and managed in a separate data base as including mapping information used for interconversion between data formats which are used by the peripheral devices 100-1 to 100-N and the data control device 300.

That is, the device-group-specific data conversion table 230 is a data base which the data management control part 220 refers to, and stores mapping information used for interconversion between data formats which are used by the peripheral devices 100-1 to 100-N and the data control device 300.

For example, when ‘0x1E’ is generated as a device data for an action of pressing ‘a’ key in a keyboard peripheral device, if it is assumed that the device data for the action (the pressing ‘a’ key) is defined as 8 bytes data (‘0x0, 0x0, 0x4, 0x0, 0x0, 0x0, 0x0, 0x0’) in the data control device 300, the mapping information used for interconversion between the above two device data may be stored in the device-group-specific data conversion table 230.

In other words, it is desirable that devices belonging to the same device group use the same device data format, and different device data formats are used by different device groups. For example, devices may be classified into several device groups (e.g. a network group including a CDMA modem, a GSM modem, a LTE modem, etc., an audio group including a microphone, a speaker, etc., a sensor group, a input device group, and the like) according to their characteristics.

Also, the data management control part 220 of the data management device 200 may control operations of all parts existing in the data management device 200. Especially, the control part 220 controls operations of the data transceiving part 210, and determine whether it transmits data generated in a specific peripheral device to the data control device 300 or another peripheral device which can receive and process the data.

Also, the data transceiving part 210 and/or the data management control part 220 of the data management device 200 may perform verification on validity (e.g. noise or packet loss) of data received through a wired or wireless communication channel 10, which is connected to the data control device 300, such as USB, 1394, WiFi, NIC, LTE, CDMA, and GSM.

Also, it is desirable that the data transceiving part 210 of the data management device 200 configures and transfers a packet according to a protocol specified as a standard.

Also, the data control device 300 is a device which is connected to the data management device 200 through a wired or wireless communication channel 10, and controls input/output data of each of the plurality of peripheral devices 100-1 to 100-N. For example, it may be a central processing unit (CPU) of a desktop computer or an application processor (AP) of an embedded device, which processes and responds to instructions for system operations. In addition, it performs a role of a core device controlling various peripheral devices connected to the system.

In this case, it is desirable that the communication channel 10 is configured with a wired or wireless communication such as a Universal Serial Bus (USB) communication, a 1394 bus communication, a WiFi communication, a Network Interface Card (NIC) communication, a Long Term Evolution (LTE) communication, a Global System for mobile communication (GSM), and a Code-Division Multiple Access (CDMA), etc. However, the communication channel 10 may not be restricted to the above examples, and may be configured with any kind of wired or wireless communication, an internet, etc.

Here, the internet means a TCP/IP protocol layer and a world-wide open type network structure providing various services over the layer such as Hyper Text Transfer Protocol (HTTP), Telnet, File Transfer Protocol (FTP), Domain Name System (DNS), Simple Mail Transfer Protocol (SMTP), Simple Network Management Protocol (SNMP), Network File Service (NFS), Network Information Service (NIS), etc., and provides an environment through which the data management device 200 can access the data control device 300. On the other hand, the internet may be provided as a wired internet or a wireless internet, or may be provided as a core network in which a wired public network, a wireless mobile network, or a portable internet are combined.

Especially, the data control device 300 may perform a function of receiving a packet having the converted device control data format from the data management device 200 through the wired or wireless communication channel 10, and transferring the packet to a virtual device driver 330 for controlling a corresponding peripheral device.

Also, the data control device 300 may perform a function of transmitting a packet having device control data format outputted from a target device driver 330 connected to a preinstalled application program (e.g. a SMS, an internet phone, a real-time TV, a voice memo, a music player, etc.) 400 to the data management device 200 through the wired or wireless communication channel 10.

Such the data control device 300, as shown in FIG. 2, comprises the data transceiving part 310 transceiving data between the data management device 200 and the data control device 300, and the data control part 320 receiving a packet having a device control data format from the data transceiving part 310 and controlling the data transceiving part 310 to transfer the packet to the virtual device driver 330 for controlling the corresponding peripheral device.

Also, the data control part 320 performs a function of controlling the data transceiving part 310 to transmit a packet having device control data format outputted from a target device driver 330 connected to a preinstalled application program 400 to the data management device 200.

Also, the data transceiving part 310 and/or the data control part 320 of the data control device 300 may perform verification on validity (e.g. noise or packet loss) of data received through the wired or wireless communication channel 10, which is connected to the data management device 200.

Also, it is desirable that the data transceiving part 310 of the data control device 300 configures and transfers a packet according to a protocol specified as a standard.

That is, the data management device 200 and the data control device 300 can configure a packet according to a predefined protocol specification, and transfer the packet to each other through the wired or wireless communication channel 10 configured with a single interface manner.

Meanwhile, it is desirable that each of the data management device 200 and the device control device 300 equips a wired or wireless communication module (not illustrated) for performing data communications through the wired or wireless communication channel 10.

Meanwhile, the above-described data management system using a device-group-specific data conversion table according to an example embodiment of the present invention, for example, may have advantages which can increase competitiveness of products when it is applied to the multi-function products such as a smart phone, a tablet PC, a home network system, and the like.

Hereinafter, the above-described method for data management using a device-group-specific data conversion table according to an example embodiment of the present invention will be explained in further detail.

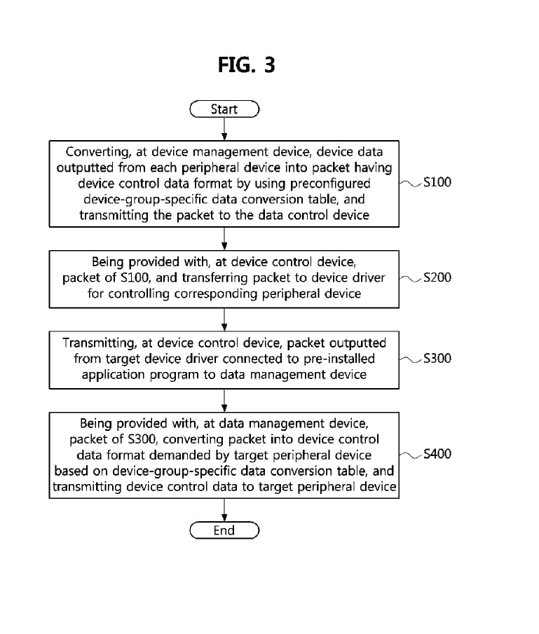

FIG. 3 is a flow chart to explain the data management method using a device-group-specific data conversion table according to an example embodiment of the present invention.

Referring to FIGS. 1 to 3, in the data management method using a device-group-specific data conversion table according to an example embodiment of the present invention, first, the data management device 200 receives device data outputted from each of the plurality of peripheral devices 100-1 to 100-N, converts the device data into a packet having a device control data format which the data control device 300 can interpret by using the preconfigured device-group-specific data conversion table 230, and transmit the packet to the data control device 300 (S100).

At this time, it is desirable that the device-group-specific data conversion table 230 includes mapping information used for mutually converting data formats which are respectively used by each of the peripheral devices 100-1 to 100-N and the data management device 300.

Meanwhile, in the step S100, the data management device 200 may receive device data outputted from each of the plurality of peripheral devices 100-1 to 100-N, and convert the device data into a corresponding packet having a device control data format by using the device-group-specific data conversion table 230. If target information of the device data outputted from a corresponding peripheral device indicates another peripheral device, target information of the another peripheral device is added to the device data by using a preconfigured target environment information, and the device data is converted into another device data format which the another peripheral device can interpret, and the converted device data may be transmitted to the another peripheral device.

Here, it is desirable that the preconfigured target environment information is stored and managed in a separate data base as defining relations between data sources and destinations in order for an arbitrary peripheral device to transmit data to or receive data from the data control device 300 or at least one other peripheral device.

On the other hand, in the step S100, the data management device 200 receives device data outputted from each of the plurality of peripheral devices 100-1 to 100-N, and performs transmission to the data control device 300 or another peripheral device. If target information of device data outputted from one of the plurality of peripheral devices 100-1 to 100-N indicates the device control device 300, the device data is converted into a packet having a corresponding device control data format by using the device-group-specific conversion table 230, and transmitted to the device control device 300. Otherwise, if target information of the device data outputted from a corresponding peripheral device indicates another peripheral device, target information of the other peripheral device is added to the device data by using a preconfigured target environment information, and the device data is converted into other device data format which the other peripheral device can interpret by using the inter-device data conversion table 240, and the converted device data may be transmitted to the another peripheral device.

At this time, it is desirable that the inter-device data conversion table 240 includes mapping information used for mutually converting data formats which are used by peripheral devices connected to each other according to the preconfigured target environment information.

Then, the packet having the device control data format transmitted in the S100 is provided from the data control device 300, and it is transferred to a virtual device driver 330 for controlling the corresponding peripheral device (S200).

After then, the packet having device control data format outputted from the target device driver 330 connected to a pre-installed application program (e.g. a SMS, an internet phone, a real-time TV, a voice memo, a music player, etc.) 400 is transmitted to the data management device 200 through the data management device 300 (S300).

On the other hand, in the steps S200 and S300, it is desirable that the data control device 300 is connected to the data management device 200 through a single wired or wireless communication channel 10, and the data control device 300 receives the packet having the converted device control data format through the wired or wireless communication channel 10, transfers the packet to the device driver 330 for controlling the corresponding peripheral device, and transmits a packet having device control data format outputted from the target device driver 330 through the pre-installed application program 400 to the data management device 200 through the single wired or wireless communication channel 10.

Also, in the steps S100 and S300, it is desirable that the data management device 200 and the data control device 300 configure a packet according to a predefined protocol specification, and transfer the packet to each other through the wired or wireless communication channel 10 configured with a single interface manner.

After then, the packet having device control data format corresponding to the target peripheral device transmitted in the step S300 through the data management device 200 is provided, converted into a device data format which the target peripheral device demands by using the device-group-specific data conversion table 230, and transmitted to the target peripheral device (S400).

Also, it is desirable that devices belonging to the same device group use the same device data format, and different device data formats are used by different device groups. For example, devices may be classified into several device groups (e.g. a network group including a CDMA modem, a GSM modem, a LTE modem, etc., an audio group including a microphone, a speaker, etc., a sensor group, a input device group, and the like) according to their characteristics.

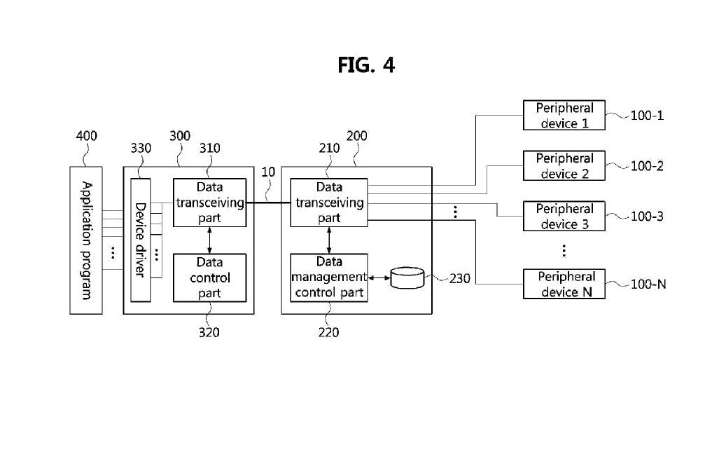

FIG. 4 is a detailed block diagram to explain a data management device and a data control device which are applied to an example embodiment of the present invention.

Referring to FIG. 1 and FIG. 4, the data management system for data communications between a plurality of peripheral devices and a data management device, according to an example embodiment of the present invention, may comprise a plurality of peripheral devices 100-1 to 100-N, a data management device 200, and a data control device 300, etc.

Here, the plurality of peripheral devices 100-1 to 100-N may include input/output devices except a central processing unit (CPU), secondary memory units, data communication devices for online systems, etc.

That is, for example, a plurality of peripheral devices for a smart phone may include a Global Positioning System (GPS) module, a Code-Division Multiple Access (CDMA) communication module, a touch panel, a speaker, a microphone, etc.

That is, for example, a plurality of peripheral devices for a smart phone may include components essential to a computer system such as a processor, a memory, a bus, etc. and components which are not essential to the computer system such as a Global Positioning System (GPS) module, a Code-Division Multiple Access (CDMA) communication module, a touch panel, a speaker, a microphone, etc.

Also, the plurality of peripheral devices may be referred to as ‘input/output devices’, and they may include devices providing or outputting some information to a main controller or a central processing unit (CPU), etc.

Meanwhile, peripheral devices such as a hard-disk, a CD-ROM drive, a network interface card, etc. may exist in a main body of the computer system together with principal components of the computer system. Otherwise, peripheral devices such as a printer, an image scanner, etc. may exist out of the main body of the computer system.

Also, the data management device 200 may be a bridge module performing a role of a communication mediator between the plurality of peripheral devices 100-1 to 100-N and the data control device, and comprise a physically-implemented chip and a firmware embedded in a chip memory. Such the data management device 220 may be upgraded for supports of new peripheral devices, bug fixing, performance enhancement, etc. by updating internal software.

Especially, the data management device 200 may be provided with device data outputted from each of the plurality of peripheral devices 100-1 to 100-N, and perform a function of converting the device data into a packet having a device control data format which the data control device 300 can interpret by using a device-group-specific data conversion data base (DB) 230, processing the packet into data blocks according to a protocol policy predefined with the data control device 300, and transmitting the processed data blocks based on scheduling performed according to a preconfigured priority.

Also, the data management device 200 may receive the data blocks transmitted from the data control device 300, reassemble the data blocks into a packet having a device control data format corresponding to a target peripheral device according to their time sequences, convert the packet into a device data format demanded by the target peripheral device according to the device-group-specific data conversion table 230, and transmit the device data to the target peripheral device.

Such the data management device 200, as shown in FIG. 4, may comprise a data transceiving part 210 transceiving data between the data control device 300 and the plurality of peripheral devices 100-1 to 100-N; and a data management control part 220 being provided with received device data of each of the plurality of peripheral devices 100-1 to 100-N from the data transceiving part 210, converting the device data into a packet having a device control data format which the data control device 300 can interpret by using the device-group-specific data conversion data base 230, processing the packet into data blocks according to a protocol predefined with the data control device 300, and transmitting the processed data blocks based on scheduling performed according to a preconfigured priority.

Also, the data management control part 220 may receive the data blocks transmitted from the data control device 300, reassemble the data blocks into a packet having a device control data format corresponding to a target peripheral device according to their time sequences, convert the packet into a device data format demanded by the target peripheral device according to the device-group-specific data conversion data base 230, and transmit the device data to the data control device 300 through the data transceiving part 210.

Also, the data transceiving part 210 and/or the data management control part 220 of the data management device 200 may perform verification on validity (e.g. noise or packet loss) of data received through the wired or wireless communication channel 10, which is connected to the data control device 300.

Also, the data management control part 220 may perform interconversion between a data format which is demanded by one of the peripheral devices 100-1 to 100-N and a data format which is demanded by the data control device 300.

For example, when ‘0x1E’ is generated as a device data for an action of pressing ‘a’ key in a keyboard peripheral device, if it is assumed that the device data for the action (the pressing ‘a’ key) is defined as ‘0x04’ in the data control device 300 according to a standard for keyboard data format, it is necessary that the actually-generated data ‘0x1E’ is converted into the data ‘0x04’ in order to notify the data control device 300 that the ‘a’ key is pressed.

As described above, the data format demanded by each of the peripheral devices 100-1 to 100-N and the data format demanded by the data control device 300 may be different from each other. In this case, the data management control part 220 can perform interconversion between the two data formats. For the interconversion, the device-group-specific conversion data base 230, in which generated values are respectively mapped onto values into which the generated values should be converted, may be used.

Here, it is desirable that the device-group-specific data conversion data base 230 is stored and managed in a table form as including mapping information used for interconversion between data formats which are used by the peripheral devices 100-1 to 100-N and the data control device 300.

That is, the device-group-specific data conversion data base 230 is a data base which the data management control part 220 refers to, and stores mapping information used for interconversion between data formats which are used by the peripheral devices 100-1 to 100-N and the data control device 300.

For example, when ‘0x1E’ is generated as a device data for an action of pressing ‘a’ key in a keyboard peripheral device, if it is assumed that the device data for the action (the pressing ‘a’ key) is defined as 8 bytes data (‘0x0, 0x0, 0x4, 0x0, 0x0, 0x0, 0x0, 0x0’) in the data control device 300, the mapping information used for interconversion between the above two device data may be stored in the device-group-specific data conversion data base 230.

Meanwhile, it is desirable that devices belonging to the same device group use the same device data format, and different device data formats are used by different device groups. For example, devices may be classified into several device groups (e.g. a network group including a CDMA modem, a GSM modem, a LTE modem, etc., an audio group including a microphone, a speaker, etc., a sensor group, a input device group, and the like) according to their characteristics.

Also, it is desirable that the data transceiving part 210 of the data management device 200 configures and transfers a packet according to a protocol specified as a standard.

Also, the data control device 300 is a device which is connected to the data management device 200 through a wired or wireless communication channel 10, and controls input/output data of each of the plurality of peripheral devices 100-1 to 100-N. For example, it may be a central processing unit (CPU) of a desktop computer or an application processor (AP) of an embedded device, which processes and responds to instructions for system operations. In addition, it performs a role of a core device controlling various peripheral devices connected to the system.

In this case, it is desirable that the communication channel 10 is configured with a wired or wireless communication such as a Universal Serial Bus (USB) communication, a 1394 bus communication, a WiFi communication, a Network Interface Card (NIC) communication, a Long Term Evolution (LTE) communication, a Global System for mobile communication (GSM), and a Code-Division Multiple Access (CDMA), etc. However, the communication channel 10 may not be restricted to the above examples, and may be configured with any kind of wired or wireless communication, an internet, etc.

Here, the internet means a TCP/IP protocol layer and a world-wide open type network structure providing various services over the layer such as Hyper Text Transfer Protocol (HTTP), Telnet, File Transfer Protocol (FTP), Domain Name System (DNS), Simple Mail Transfer Protocol (SMTP), Simple Network Management Protocol (SNMP), Network File Service (NFS), Network Information Service (NIS), etc., and provides an environment through which the data management device 200 can access the data control device 300. On the other hand, the internet may be provided as a wired internet or a wireless internet, or may be provided as a core network in which a wired public network, a wireless mobile network, or a portable internet are combined.

Especially, the data control device 300 may perform a function of receiving data blocks transmitted from the data management device 200, reassembling the data blocks into a packet having a device control data format according to their time sequences, and transmitting the packet to a virtual device driver 330 for controlling a corresponding peripheral device.

Also, the data control device 300 may perform a function of converting date outputted from the target device driver 330 connected to a pre-installed application program (e.g. a SMS, an internet phone, a real-time TV, a voice memo, a music player, etc.) 400 into a packet having a device control data format which the data management device 200 can interpret, and processing the packet into data blocks according the predefined protocol specification, and transmitting the processed data blocks based on scheduling performed according to a preconfigured priority.

Here, the application program 400, for example, may be an application program having a specific purpose such as a Microsoft Word, a Microsoft Excel, a Hangeul word processor, a game, etc. Generally, the application program 400 uses resources of the peripheral devices 100-1 to 100-N. For example, a word processor application uses a keyboard and a mouse, and a video player application uses a display device and a speaker device.

Also, the virtual device driver 330 may be a kind of program which can be used for a program having a level identical to that of the application program 400 to interwork with a hardware device. That is, the device driver acts as a kind of mediator which gives a command to a hardware device and receives data in response to the command from the hardware device. The device driver 330 exchanges data with the peripheral devices 100-1 to 100-N by using a bus connected physically to the peripheral devices 100-1 to 100-N and a lower-level communication system.

The data control device 300, as shown in FIG. 4, may comprise a data transceiving part 310 transceiving data between the data management device 200 and the data control device 300; and a data control part 320 being provided with received data blocks from the data transceiving part 310, reassembling the data blocks into a packet having a device control data format according to their time sequences, and transferring the packet to the virtual device driver 330 for controlling the corresponding peripheral device.

Also, the data control part 320 may perform a function of converting data outputted from the target device driver 330 connected to the pre-installed application program into a packet having device control data format which the data management device 200 can interpret, and processing the packet into data blocks according the predefined protocol specification, and controlling the data transceiving part 310 to transmit the processed data blocks to the data management device 200 based on scheduling performed according to a preconfigured priority.

Also, the data transceiving part 310 and/or the data control part 320 of the data control device 300 may perform verification on validity (e.g. noise or packet loss) of data received through the wired or wireless communication channel 10, which is connected to the data management device 200.

Also, it is desirable that the data transceiving part 310 of the data control device 300 configures and transfers a packet according to a protocol specified as a standard.

That is, the data management device 200 and the data control device 300 can configure a packet according to a predefined protocol specification, and transfer the packet to each other through the wired or wireless communication channel 10 configured with a single interface manner.

Meanwhile, it is desirable that each of the data management device 200 and the device control device 300 equips a wired or wireless communication module (not illustrated) for performing data communications through the wired or wireless communication channel 10.

Meanwhile, the above-described data management system for data communications between a plurality of peripheral devices and a data control device, according to an example embodiment of the present invention, for example, may have advantages that it can provide various cost savings and product competitiveness when it is applied to an embedded device implementing multi-functions in an environment where function expansion is not easy, such as a smart phone, a machine-to-machine (M2M) device, a tablet PC, a navigation, a home network system, etc.

Hereinafter, a method for data management using a data management system for data communications between a plurality of peripheral devices and a data control device, according to an example embodiment of the present invention, will be explained in further detail.

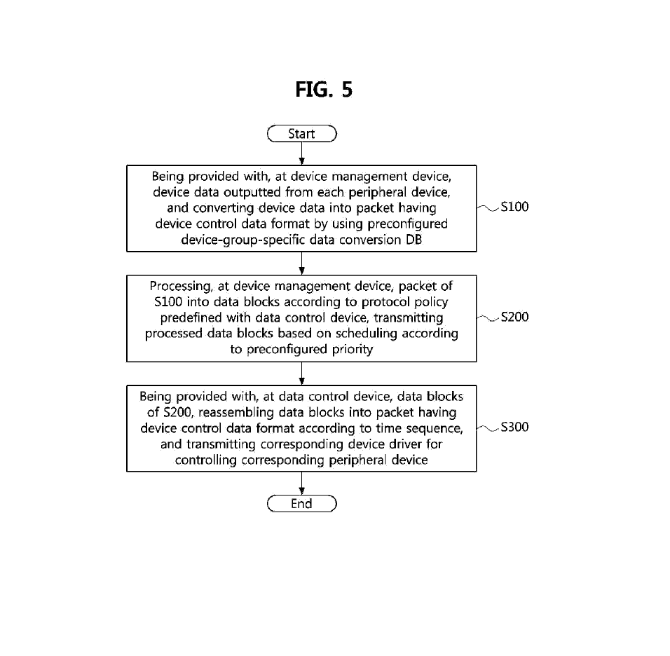

FIG. 5 is a flow chart to explain the data management method for data communications between a plurality of peripheral devices and a data control device according to an example embodiment of the present invention.

Referring to FIGS. 1, 4, and 5, in the data management method for data communications between a plurality of peripheral devices and a data control device according to an example embodiment of the present invention, first, the data management device 200 receives device data outputted from each of the plurality of peripheral devices 100-1 to 100-N, converts the device data into a packet having device control data format which the data control device 300 can interpret by using the preconfigured device-group-specific data conversion table 230 (S100).

At this time, it is desirable that the device-group-specific data conversion table 230 includes mapping information used for mutually converting data formats which are respectively used by each of the peripheral devices 100-1 to 100-N and the data management device 300. Also, it is desirable that the mapping information is stored and managed in a table form.

Then, the data management device 200 processes the packet converted in the step S100 into data blocks according to a protocol predefined with the data control device 300, divides the data blocks into basic transmission units each of which has a corresponding sequence identification number, and transmits them based on scheduling performed according to a preconfigured priority (that is, priorities assigned to each peripheral device or dynamic priorities of data according to real-time situation) (S200).

After then, the data control device 300 receives the data blocks transmitted in the step S200, reassembles the data blocks into a packet having device control data format according to their sequence identification numbers, transmits the packet to the virtual device driver 330 for controlling the corresponding peripheral device (S300).

Additionally, it is desirable that the method further comprise, after the step S300, a first step in which the data management device 300 converts data outputted from the target device driver 330 through the pre-installed application program 400 into a packet having a device control data format which the data management device 200 can interpret; a second step in which the data control device 300 processes the packet which is converted in the first step into data blocks according to a protocol policy predefined with the data management device 200, and transmits the processed data blocks based on scheduling performed according to a preconfigured priority; and a third step in which the data management device 200 receives the data blocks transmitted in the second step, reassembles the data blocks into a packet having a device control data format corresponding to the target peripheral device, converts the packet into a device control data format demanded by the target peripheral device by using the device-group-specific data conversion table 230, and transmits the device control data format.

Also, the data management device 200 and the data control device 300 can configure a packet according to a predefined protocol specification, and transfer the packet to each other through the wired or wireless communication channel 10 configured with a single interface manner.

Meanwhile, the data management method according to the present invention may also be implemented as program codes on a computer-readable medium which a computer can read. The computer-readable medium may include various storage devices in which data and program codes which a computer can read are stored.

For example, the computer-readable medium may include a ROM, a RAM, a CD-ROM, a magnetic table, a hard disc, a floppy disk, a removable storage device, a non-volatile memory (e.g. flash memory), an optical data storage device, etc. Also, the computer-readable medium may be distributed on computer systems connected through a computer communication network, and the program codes may be stored thereon as codes which can be read in distributed manner.

While the example embodiments of the present invention and their advantages have been described in detail, it should be understood that various changes, substitutions and alterations may be made herein without departing from the scope of the invention.

1. A data management system using a device-group-specific data conversion table, the system comprising:
a plurality of peripheral devices;
a data control device for controlling input/output data of each of the plurality of peripheral devices; and
a data management device connected between the plurality of peripheral devices and the data control device in order to manage data communications between them,
wherein the data management device is provided with device data outputted from each of the plurality of peripheral devices, and converts the device data into a packet having a device control data format which the data control device can interpret by using a preconfigured device-group-specific data conversion table,
wherein the data management device is provided with a packet having a device control data format corresponding to a target peripheral device transmitted from the device control device, and converts the packet into a device control data format which the target peripheral device demands by using the preconfigured device-group-specific data conversion table.

2. The system of claim 1, wherein the data management device comprises:
a data transceiving part transceiving data between the data control device and each of the plurality of peripheral devices; and
a data management control part being provided with received device data of each of the plurality of peripheral devices from the data transceiving part, converting the received device data into a packet having a device control data format which the device control device can interpret by using the device-group-specific data conversion table, controlling the data transceiving part to transmit the packet to the data control device, being provided with a received packet having a device control data format corresponding to the target peripheral device from the data transceiving part, converting the packet into a device control data format demanded by the target peripheral device by using the preconfigured device-group-specific data conversion table, and controlling the data transceiving part to transmit the device control data format to the target peripheral device.

3. The system of claim 2, wherein the data management control part is provided with device data outputted from each of the plurality of peripheral devices from the data transceiving part, converts the device data into a packet having a device control data format by using the device-group-specific data conversion table, adds target information of another peripheral device to the device data if a target of the device data is the another peripheral device, converts the device data into a device control data format which the another peripheral device can interpret by using the device-group-specific data conversion table, and controls the data transceiving part to transmit the device control data format to the another peripheral device.

4. The system of claim 2, wherein the data management control part is provided with device data outputted from each of the plurality of peripheral devices through the data transceiving part, and controls the data transceiving part to transmit the device data to the data management device or another peripheral device according to target information of the device data,
wherein, when the target information of the device data indicates the data control device, the data management control part converts the device data into a packet having a corresponding device control data format by using the device-group-specific data conversion table, and controls the data transceiving part to transmit the packet to the data control device,
wherein, when the target information of the device data indicates the another peripheral device, the data management control part converts the device data into a device control data format which the another peripheral device can interpret by using a preconfigured inter-device data conversion table, and controls the data transceiving part to transmit the device control data format to the another peripheral device.

5. The system of claim 4, wherein the inter-device data conversion table includes mapping information for interconversion between data formats used by the plurality of peripheral devices connected to each other.

6. The system of claim 1, wherein the data control device is connected to the data management device through a single unified communication channel, is provided with a packet having a device control data format from the data management device through the single unified communication channel, and transfers the packet to a device driver for controlling a corresponding peripheral device,
wherein the data control device is provided with a packet having a device control data format outputted from a target device driver connected to a preinstalled application program, and transmits the packet to the data management device through the single unified communication channel.

7. The system of claim 1, wherein the device-group-specific data conversion table includes mapping information for interconversion between data formats used by the data control device and the plurality of peripheral devices.

8. The system of claim 1, wherein the data management device and the data control device configure a packet according to a predefined protocol specification, and transmit the packet to each other through a communication channel using a single interface manner.

9. The system of claim 1, wherein the device-group-specific data conversion table classifies the plurality of peripheral devices into at least one device group according to characteristic of each of the plurality of peripheral devices, and peripheral devices belonging to a same device group use a same data format to perform data communications, and peripheral devices belonging to different device groups use different data formats to perform data communications.

10. A method of efficient data communication for a system comprising a plurality of peripheral devices, a data control device controlling input/output data of the plurality of peripheral devices, and a data management device between them, the method comprising:
(a) receiving, at the data management device, device data outputted from each of the plurality of peripheral devices, converting the device data into a packet having a device control data format which the data control device can interpret by using a preconfigured device-group-specific data conversion table, and transmitting the packet to the device control device;
(b) receiving, at the data control device, the packet transmitted in the step (a), and transferring the packet to a device driver for controlling a corresponding peripheral device;
(c) transferring, at the data control device, a packet having a device control data format outputted from a target device driver connected to a pre-installed application program; and
(d) being provided, at the data management device, with a packet having a device control data format outputted from a target device driver, converting the packet into a device data format which a corresponding target peripheral device demands by using the device-group-specific data conversion table, and transmitting the device data format to the target peripheral device.

11. The method of claim 10, wherein, in the step (a), the data management device is provided with device data outputted from each of the plurality of peripheral devices, converts the device data into a packet having a device control data format by using the device-group-specific data conversion table, adds target information of another peripheral device to the device data if a target of the device data is the another peripheral device, converts the device data into a device control data format which the another peripheral device can interpret by using the device-group-specific data conversion table, and transmits the converted device control data format to the another peripheral device.

12. The method of claim 10, wherein, in the step (a), the data management device is provided with device data outputted from each of the plurality of peripheral devices, and transmits the device data to the data control device or another peripheral device according to target information of the device data,
wherein, in the step (a), when the target information of the device data indicates the data control device, the data management device converts the device data into a packet having a corresponding device control data format by using the device-group-specific data conversion table, and transmits the packet to the data control device,
wherein, in the step (a), when the target information of the device data indicates another peripheral device, the data management device converts the device data into a device control data format which the another peripheral device can interpret by using a preconfigured inter-device data conversion table, and transmits the device control data format to the another peripheral device.

13. The method of claim 12, wherein the inter-device data conversion table includes mapping information for interconversion between data formats used by the plurality of peripheral devices connected to each other.

14. The method of claim 10,
wherein, in the steps (b) and (c), the data control device is connected to the data management device through a single unified communication channel, is provided with a packet having a device control data format from the data management device through the single unified communication channel, and transfers the packet to a device driver for controlling a corresponding peripheral device,
wherein, in the steps (b) and (c), the data control device is provided with a packet having a device control data format outputted from a target device driver through the single unified communication channel, and transmits the packet to the data management device through the single unified communication channel.

15. The method of claim 10, wherein the device-group-specific data conversion table includes mapping information for interconversion between data formats used by the data control device and the plurality of peripheral devices.

16. The method of claim 10, wherein the device-group-specific data conversion table classifies the plurality of peripheral devices into at least one device group according to characteristic of each of the plurality of peripheral devices, and peripheral devices belonging to a same device group use a same data format to perform data communications, and peripheral devices belonging to different device groups use different data formats to perform data communications.

17. A data management system for data communications between a plurality of peripheral devices and a data control device, the system comprising:
a plurality of peripheral devices;
a data management device receiving device data outputted from each of the plurality of peripheral devices, converting the device data into a packet having a device control data format corresponding to a device group to which the each of the plurality of peripheral devices belongs by using a preconfigured device-group-specific data conversion data base, processing the packet into data blocks according to a protocol policy predefined with the data control device; and transmitting the data block based on scheduling performed according to a preconfigured priority; and
a data control device receiving the data blocks, reassembling the data blocks into a packet having a device control data format according to their time sequences, and transmitting the packet to a device driver for controlling the corresponding peripheral device.

18. The method of claim 17,
wherein the data control device converts data outputted form a target device driver connected to a pre-installed application program into a packet having a device control data format which the data management device can interpret, processes the packet into data blocks according to a protocol policy predefined with the data management device, and transmit the processed data blocks based on scheduling performed according to a preconfigured priority,
wherein the data management device is provided with the data blocks from the data control device, reassembles the data blocks into a packet having a device control data format corresponding to a target peripheral device according to their time sequences, converts the packet into a device control data format demanded by the target peripheral device by using the device-group-specific data conversion data base, and transmits the device control format to the target peripheral device.

19. The method of claim 17, wherein the data management device and the data control device configure a packet according to a predefined protocol specification, and transmit the packet to each other through a communication channel using a single interface manner.

20. The method of claim 17, wherein the device-group-specific conversion data base stores and manages mapping information for interconversion between data formats used by the data control device and the plurality of peripheral devices as a data base having a table form.

21. A method of efficient data communication for a system comprising a plurality of peripheral devices, a data control device controlling input/output data of the plurality of peripheral devices, and a data management device between them, the method comprising:
(a) being provided, at the data management device, with device data outputted from a peripheral device, and converting the device data into a packet having a device control data format corresponding to a device group to which the peripheral device belongs which the data control device can interpret by using a preconfigured device-group-specific data conversion data base;
(b) processing, at the data management device, the packet into data blocks according to a protocol policy predefined with the data control device, and transmitting the data blocks based on scheduling performed according to a preconfigured priority; and
(c) being provided, at the data control device, with the data blocks, reassembling the data blocks into a packet having a device control data format according to time sequence, and transmitting the packet to a virtual device driver for controlling a corresponding peripheral device.

22. The method of claim 21, further comprising, after the step (c),
(d) converting, at the data control device, data outputted from a target device driver connected to a pre-installed application program into a packet having a device control data format which the data management device can interpret;
(e) processing, at the data control device, the packet into data blocks according to a protocol policy predefined with the data management device, and transmitting the data blocks based on scheduling performed according to a preconfigured priority; and
(f) being provided, at the data management device, with the data blocks, reassembling the data blocks into a packet having a device control data format according to their time sequences, converting the packet into a device data format demanded by a corresponding target peripheral device by using the device-group-specific data conversion data base, and transmitting the device data format to the corresponding peripheral device.

23. The method of claim 21, wherein the data management device and the data control device configure a packet according to a predefined protocol specification, and transmit the packet to each other through a communication channel using a single interface manner.

24. The method of claim 21, wherein the device-group-specific conversion data base stores and manages mapping information for interconversion between data formats used by the data control device and the plurality of peripheral devices as a data base having a table form.
